(19) United States
(12) Patent Application Publication
(10) Pub. No.: US 2025/0217027 A1
(43) Pub. Date: Jul. 3, 2025

(54) METHOD AND SYSTEM FOR PROVIDING CONTENT

(71) Applicant: NAVER WEBTOON Ltd., Seongnam-si (KR)

(72) Inventors: JI HOON ROH, Seongnam-si (KR); SOO YEON KANG, Seongnam-si (KR); HYE WON JEONG, Seongnam-si (KR); WON JOON CHEE, Seongnam-si (KR); MIN AH CHOI, Seongnam-si (KR); HEE JAE AHN, Seongnam-si (KR); NA YONG KIM, Seongnam-si (KR); SEUNG CHUL LEE, Seongnam-si (KR); SEUNG HO HYUN, Seongnam-si (KR); YOUNG CHAE LIM, SE (KR); BO BAE KIM, Seongnam-si (KR)

(21) Appl. No.: 19/001,820

(22) Filed: Dec. 26, 2024

(30) Foreign Application Priority Data
Dec. 27, 2023 (KR) 10-2023-0193396

(51) Int. Cl. G06F 3/0485; G06F 3/0481

(52) U.S. Cl. CPC G06F 3/0485; G06F 3/0481

(57) ABSTRACT

A method of providing content includes providing preview content for specific content in a preset preview area corresponding to at least a portion of a display area, changing, based on receiving a scroll request for the preview area, an output range of the preview content output in the preview area, and providing, based on the output range of the preview content corresponding to a preset range, a graphic object related to viewing the specific content in the preview area.

### CROSS REFERENCE TO RELATED APPLICATION

The present application claims priority to Korean Patent Application No. 10-2023-0193396, filed on Dec. 27, 2023, the entire contents of which are incorporated herein for all purposes by reference.

### BACKGROUND OF THE INVENTION

### Field of the Invention

The present invention relates to a method and a system for providing content to a user.

### Description of the Related Art

With advancements in technology, digital devices are becoming increasingly utilized. In particular, a user terminal (e.g., smartphone, tablet PC, etc.) is equipped with various functions including communication functions such as phone calls or text messaging, as well as surfing the web, listening to music, and watching video content using the Internet.

With the popularization of user terminals, the content industry is experiencing remarkable growth. Content refers to various types of information or materials provided through the Internet or computer communications, which may come in a variety of types. For example, content may include webcomics, comics web novels, music, e-books, articles, videos, TV program footage, images, etc.

A representative example of actively consumed content is webcomics, which are comics that are serialized and distributed over the Internet communication network, a compound of “web” and “comics”.

As the consumption of such webcomics continues to steadily increase, various webcomic-related service providers are developing various services to attract many consumers to their webcomics and encourage their consumption. As an example, some webcomic-related service providers segment the content of a book into multiple episodes to provide to consumers, thereby guiding continued consumption of these episodes.

As another example, Korean Patent Publication No. 10-2015-0085195 (Method and System for Providing Webcomics with Animation Effects to User Terminal) proposes a method of providing webcomics with animation effects to consumers, thereby enhancing consumers' understanding of webcomics.

As such, various studies are being conducted to increase consumer consumption and interest in content. As described above, there is still a need to improve consumer purchasing intent for content to attract more consumers and maintain ongoing consumption of content.

### SUMMARY OF THE INVENTION

The present invention relates to a method and a system for providing content that allows users to easily access the content.

More specifically, the present invention relates to a method and a system for providing content that is capable of providing a preview of the content.

Further, the present invention relates to a method and a system for providing content for providing a user environment in which content is continuously available following a preview.

Further, the present disclosure relates to a method and a system for providing content that is capable of guiding a user to continuously consume the content.

To achieve the aforementioned objects, there is provided a method of providing content. The method may include providing preview content for specific content in a preset preview area corresponding to at least a portion of a display area, changing, based on receiving a scroll request for the preview area, an output range of the preview content output in the preview area, and providing, based on the output range of the preview content corresponding to a preset range, a graphic object related to viewing the specific content in the preview area.

Also, there is provided a system for providing content, according to the present invention. The system may include a control unit configured to provide preview content for specific content in a preset preview area corresponding to at least a portion of the display area, in which the control unit may change, based on receiving a scroll request for the preview area, an output range of the preview content output in the preview area, and provide, based on the output range of the preview content corresponding to a preset range, a graphic object related to viewing the specific content in the preview area.

Further, there is provided a program storable on a non-transitory computer-readable recording medium, and executed by one or more processes in an electronic device, according to the present invention. The program may include instructions to allow the program to perform: providing preview content for specific content in a preset preview area corresponding to at least a portion of the display area; changing, based on receiving a scroll request for the preview area, an output range of the preview content output in the preview area; and providing, based on the output range of the preview content corresponding to a preset range, a graphic object related to viewing the specific content in the preview area.

As described above, the method and the system for providing content according to the present invention may provide preview content for specific content in a preset preview area corresponding to at least a portion of the display area. The user may identify specific content in advance through the preview content and may easily determine which content the user wishes to use through the content preview identified in advance. Therefore, the user may more easily access new content.

Further, the method and the system for providing content according to an aspect of the present invention may change the output range of the preview content output in the preview area, based on receiving a scroll request for the preview area. The user may conveniently use the preview content with simple operations.

Moreover, the method and the system for providing content according to an aspect of the present invention may provide a graphic object related to viewing specific content in the preview area, based on the output range of the preview content corresponding to a preset range. Therefore, the user may conveniently obtain information on new content and easily access interesting content without needing to perform separate actions, such as searching. Further, the user may continuously use the content in succession to the preview content. Further, the content provider may effectively guide the consumption of content by the consumer and ensure continuous consumption of content by the consumer, thereby preventing consumer churn.

### BRIEF DESCRIPTION OF THE DRAWINGS

FIG. 1 is a block diagram of a system for providing content according to the present invention.

FIG. 2 is a flowchart for describing a method of providing content according to the present invention.

FIGS. 3A, FIG. 3B, FIG. 3C, FIG. 3D, FIG. 3E, and FIG. 3F are diagrams for describing a method of providing content through a preview.

FIG. 4, FIGS. 5A and 5B, and FIG. 6 are diagrams for describing a method of activating tabs that fit conditions, depending on whether content is viewed in a user account.

FIG. 7, FIG. 8, and FIGS. 9A and 9B are diagrams for describing a user environment in which a content preview function is provided.

### DETAILED DESCRIPTION OF THE INVENTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The terms “module”, “unit”, “part”, and “portion” used to describe constituent elements in the following description are used together or interchangeably in order to facilitate the description, but the terms themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, the accompanying drawings are provided to allow those skilled in the art to understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

Singular expressions include plural expressions unless clearly described as different meanings in the context.

The present invention relates to a method and a system for providing content, which may provide a preview of the content to a user in order to effectively guide the user's content consumption.

Here, a preview may refer to information or media provided to allow a user to identify a specific product in advance before purchasing the same or using a specific service. For example, a movie trailer, a demo game, a screenshot of an application, a video (or book) preview, or a one-minute preview of music may correspond to a preview.

Further, the present invention may provide a user environment in which the user can more easily access new content and continuously use the content by activating tabs that fit the conditions according to a content viewing history in a user account.

Therefore, user interest in content may be encouraged, and continuous content consumption by the user may be ensured, thereby preventing user chum.

As described above, a content providing service of the present invention may not only provide content, but also provide a service that provides a user-customized environment related to content usage.

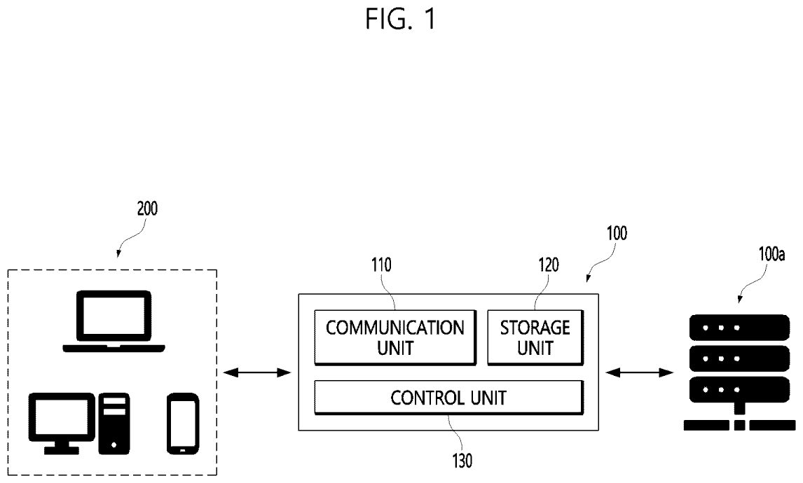

Here, the term “content providing service” may be understood as a term that comprehensively includes and refers to services provided by a system 100 shown in FIG. 1 for providing content according to the present invention. The content providing service may be understood as providing a service for providing content to a user terminal 200, as well as information related to the content, and various functions necessary for using the content.

The system 100 for providing content described in the present invention may be configured as a system for providing at least one of various types of content.

The types of content to which the present invention may be applied may be very diverse. For example, at least one type of content, such as webcomics, web novels, music, e-books, videos, or images, may correspond to the content provided in the present invention.

Such content may be configured of a plurality of sub-content. A plurality of sub-content may make up a series of the content.

Here, a series may refer to a continuous planned work or content.

In the present invention, the term “sub-content” may be referred to as an “episode” to avoid confusion between the terms content and sub-content. That is, the terms “sub-content” and “episode” may be used interchangeably in the present invention.

Furthermore, “using (consuming or viewing) content” may be understood as using (consuming or viewing) an episode (or sub-content).

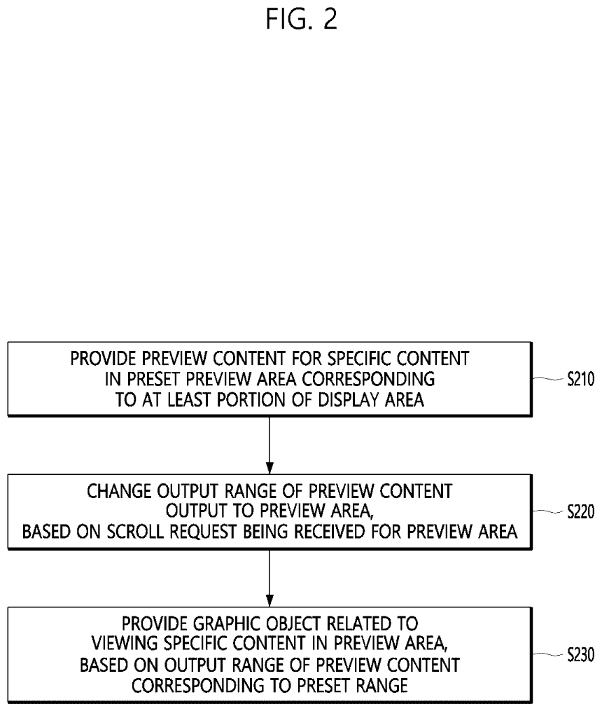

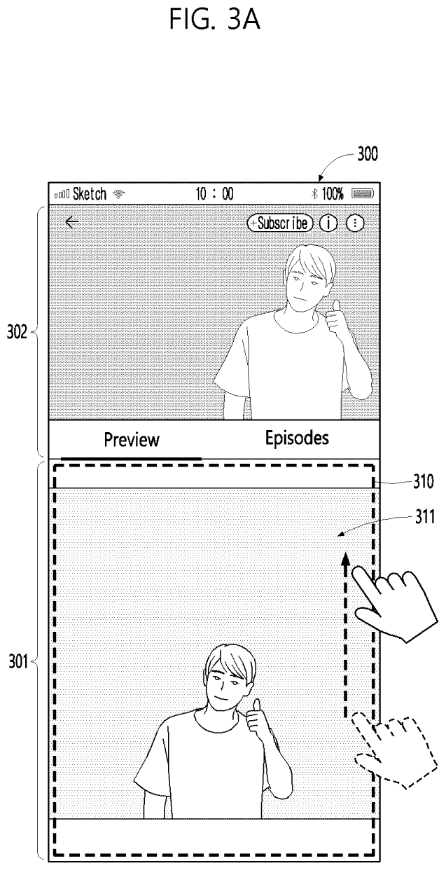

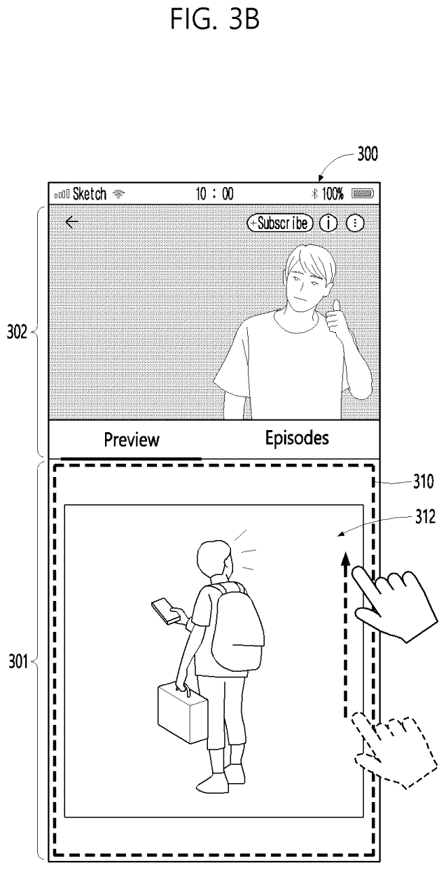

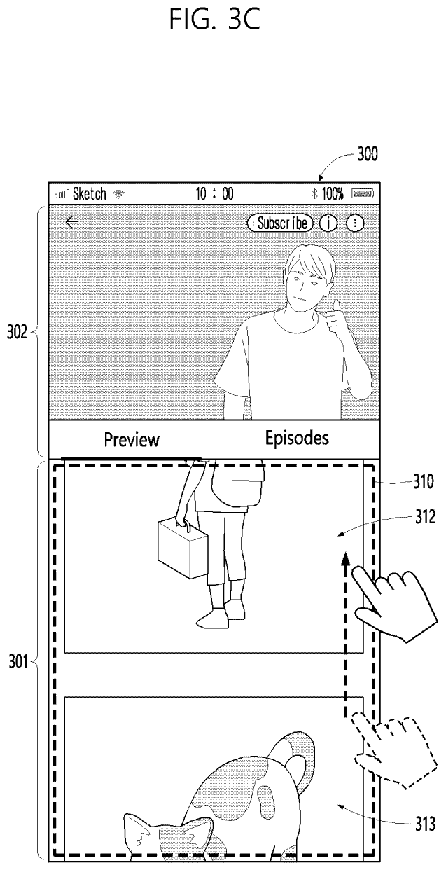

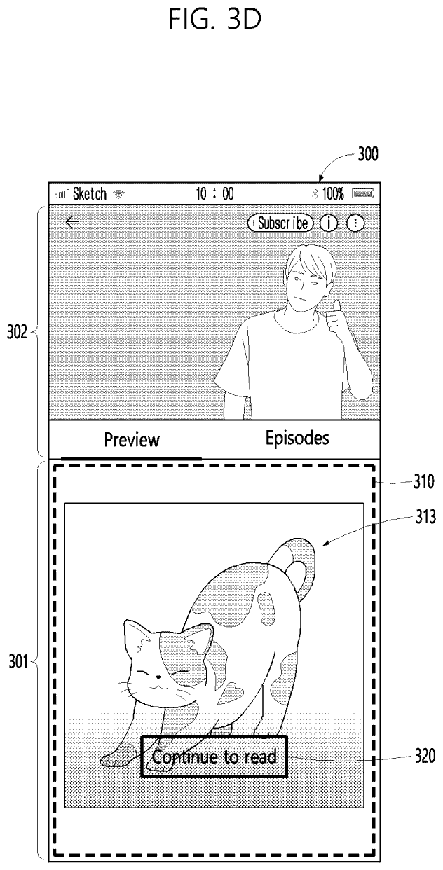

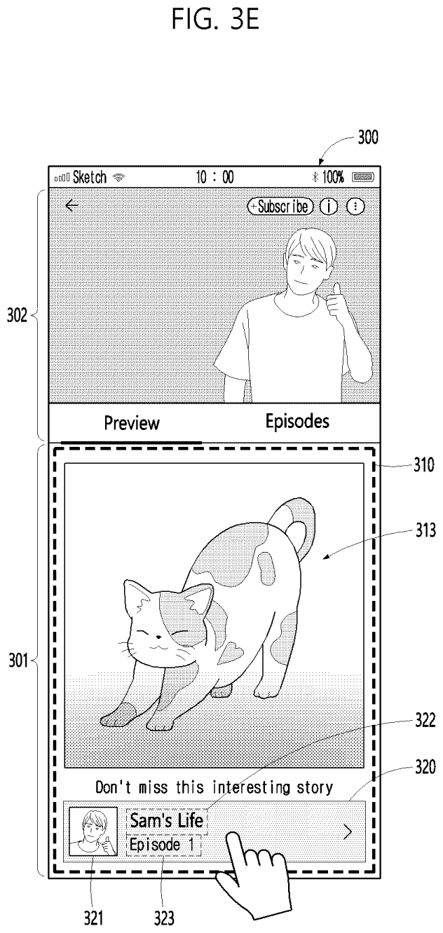

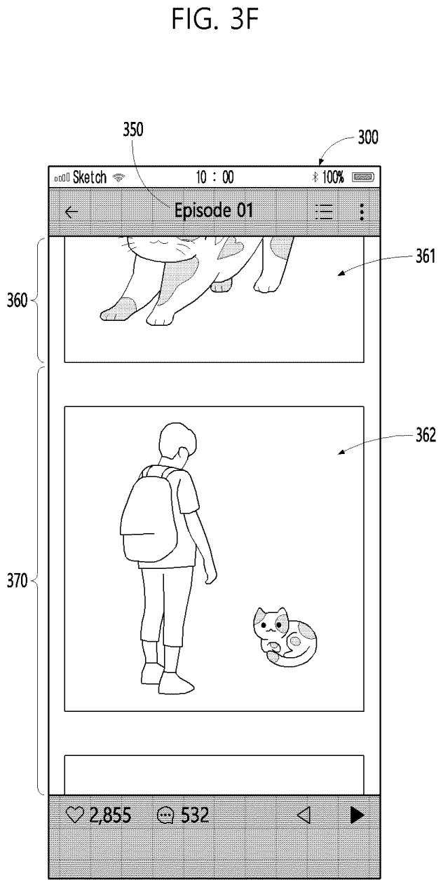

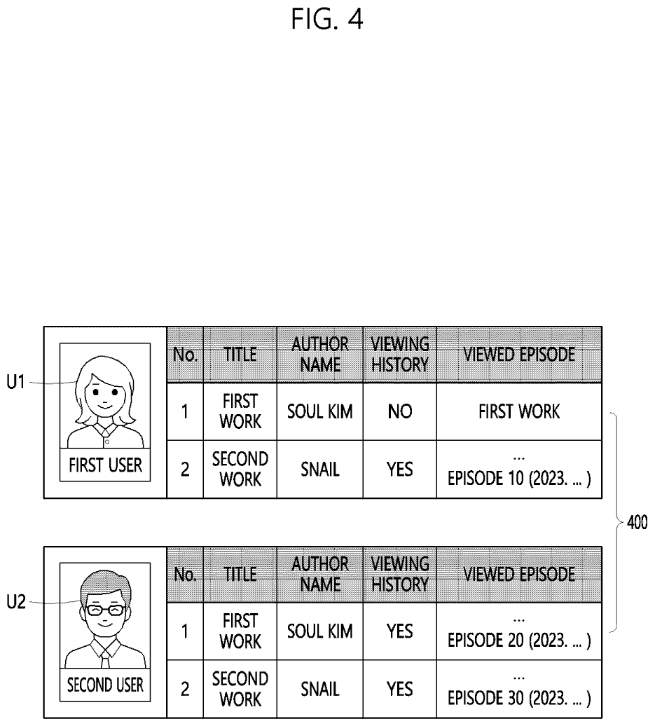

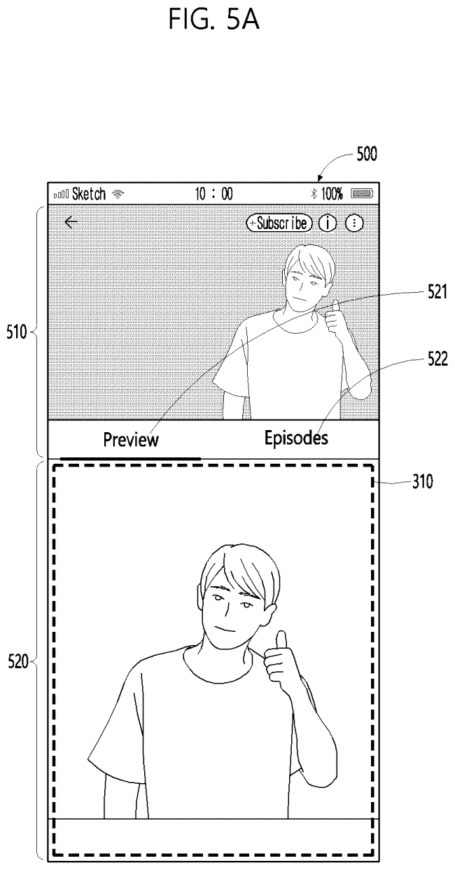

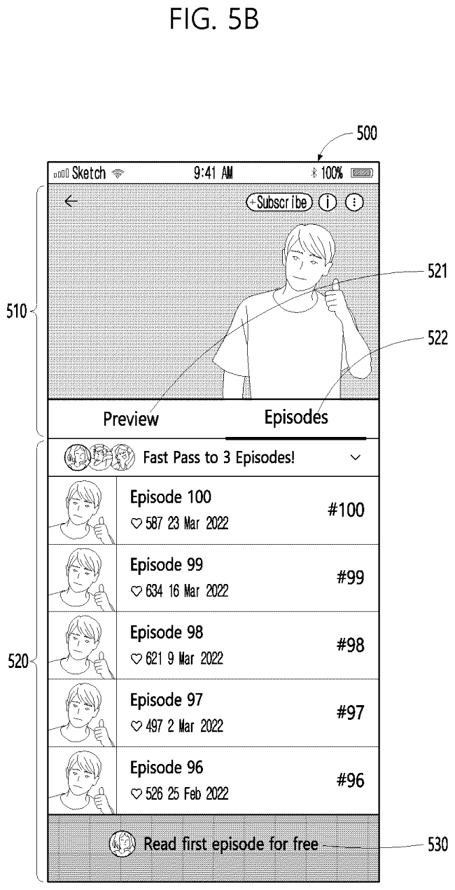

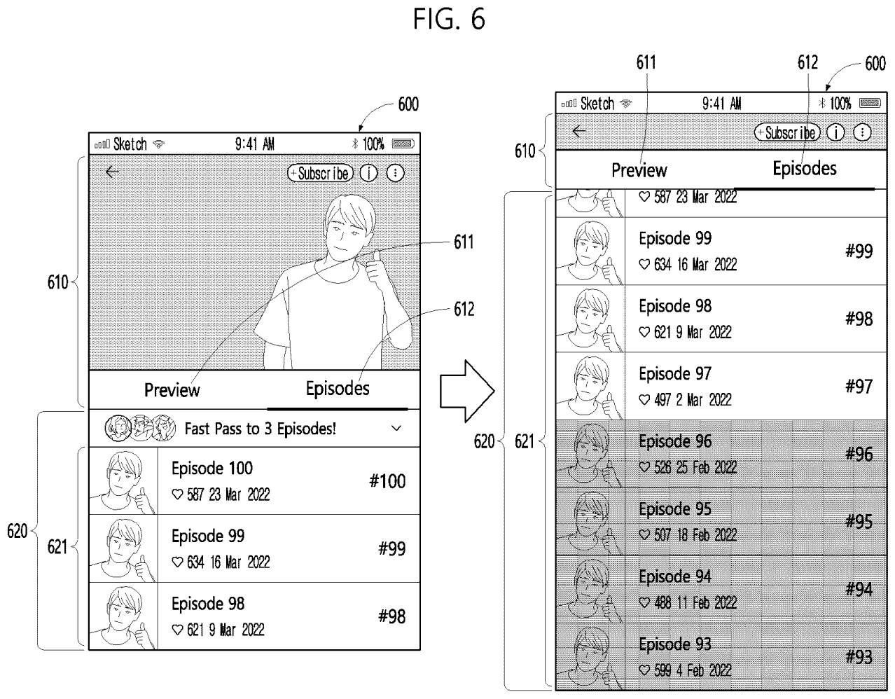

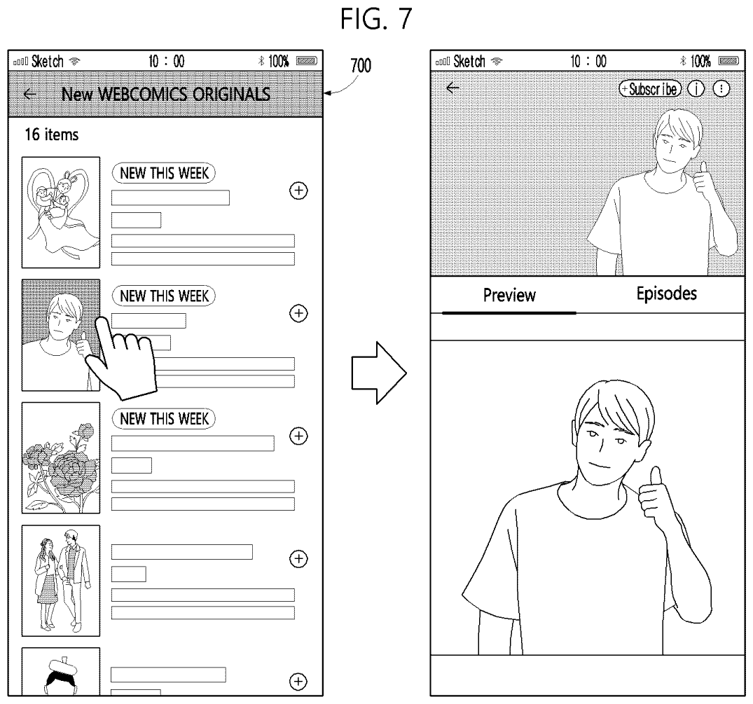

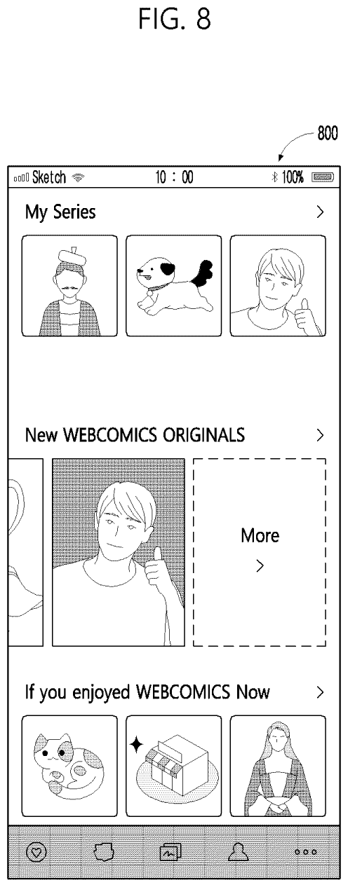

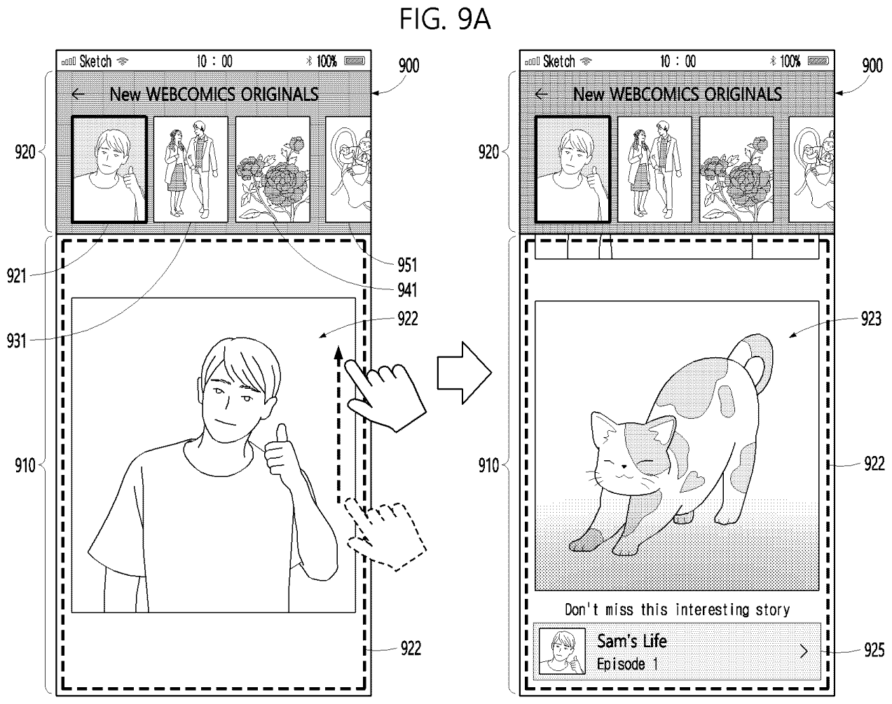

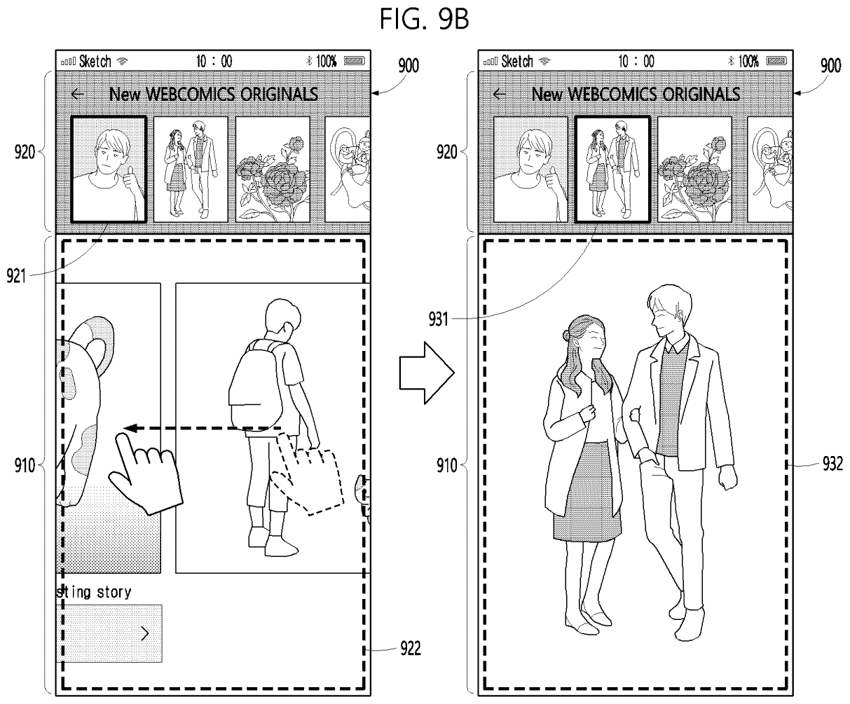

Hereinafter, a method of providing content to a user will be described in more detail, with reference to the accompanying drawings. FIG. 1 is a block diagram for describing the system 100 for providing content according to the present invention. FIG. 2 is a flowchart for describing a method of providing content according to the present invention. FIGS. 3A, FIG. 3B, FIG. 3C, FIG. 3D, FIG. 3E, and FIG. 3F are diagrams for describing a method of providing content through a preview, FIG. 4, FIG. 5, and FIG. 6 are diagrams for describing a method of activating tabs that fit conditions, depending on whether content is viewed in a user account, and FIG. 7, FIG. 8, FIG. 9A, and FIG. 9B are diagrams for describing a user environment in which a content preview function is provided.

As illustrated in FIG. 1, the system 100 for providing content according to the present invention may include at least one of a communication unit 110, a storage unit 120, or a control unit 130.

The communication unit 110 may perform the role of providing (or transmitting) content or content-related information to the user terminal 200 through wired or wireless communication with the user terminal 200.

Here, the user terminal 200 may include at least one of a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), a head mounted display (HMD)), or the like.

Although not illustrated, the user terminal 200 may include at least one of a display unit for outputting information or an input unit for receiving information from the user.

The display unit and the input unit of the user terminal 200 may exist independently of each other, but may be integrated, such as a touch screen. In the case where the display unit and the input unit are integrated, such as a touch screen, the input unit may be understood as a sensing unit that detects input (e.g., touch input, scroll input, etc.) through the display unit, which forms part of the display unit.

Hereinafter, without separately distinguishing whether the display unit and the input unit of the user terminal 200 exist independently or are integrated, the configuration that performs the function of outputting information will be referred to as the display unit and the configuration that performs the function of receiving information will be referred to as the input unit.

Next, the storage unit 120 may be configured to store various information related to the content usage. Such storage unit 120 may include a content server 100a that includes information on a plurality of content.

The information related to the content providing service of the present invention may be stored, at least partially, in the content server 100a, and the present invention does not place any particular restrictions on the manner. Accordingly, hereinafter, the storage unit 120 and the content server 100a will not be separately distinguished, and may be referred to as the storage unit 120.

In addition, hereinafter, the content server 100a and content database (DB) will not be separately distinguished, and may be collectively referred to as the content server 100a. That is, the content server 100a described in the present invention may also be understood as a content DB.

Further, the content server 100a storing the plurality of content may exist in a separate configuration from the storage unit 120. In this case, the system 100 for providing content according to the present invention may control the content server 100a to provide information stored in the content server 100a to the user terminal 200.

For example, the control unit 130 may control the content server 100a to provide content stored in the content server 100a to the user terminal 200.

In the storage unit 120, user information subscribed to a service (e.g., a content providing service) provided by the system 100 for providing content (or content providing system) according to the present disclosure may exist to be stored.

Such user information may include information on a user account (e.g., identification (ID)). The user may use the webcomic content provided by the present invention by logging into the system 100 for providing content according to the present invention with the user account.

Further, history information linked to the user account may exist to be stored in the storage unit 120.

The history information may include various information on the user account related to the services provided by the system 100 for providing content.

Specifically, the history information may include at least one of i) history information on content (or episodes) used (or viewed) by the user account (or the user terminal 200 logged in with the user account) (e.g., information on the title of the viewed content, episode number of the viewed episode, date and time of viewing, etc.), or ii) feedback information from the user account on specific content (e.g., review information, comment information, rating information, reaction information on content recommendations (e.g., history of selecting a closing style icon for a pop-up window related to specific content)).

The control unit 130 may perform a series of processes related to the present invention, and may serve to control the overall operation of the system 100 for providing content.

The control unit 130 may process signals, data, information, and the like that are input or output through the constituent elements described above, or may provide or process appropriate information and functions to a user.

Hereinafter, a method of effectively guiding user consumption of content by providing preview content for specific content to the user will be described in more detail.

In the present invention, a process of providing preview content for specific content may be performed in a preset preview area corresponding to at least a portion of the display area (S210, see FIG. 2).

As illustrated in FIG. 3A, the control unit 130 may provide preview content 310 to the user terminal 200 so that the preview content 310, having a preset length, is output in at least a partial area 301 of the display area 300 of the user terminal 200.

Here, the preview content may be understood as preview content or teaser content that shows at least a portion of specific content in advance.

More specifically, in the present invention, “specific content” may be configured to be made up of a plurality of episodes. Further, an episode may be made up of a plurality of cut images (or scene images).

The preview content described in the present specification may be configured to include at least one of a plurality of cut images that make up a specific episode (e.g., episode 1) of the plurality of episodes.

For example, assuming that a specific episode is made up of 10 cut images, the preview content 310 may be configured to include a first cut image (see reference numeral “311” in FIG. 3A), second cut image (see reference numeral “312” in FIG. 3B), and a third cut image (see reference numeral “313” in FIG. 3C), which are consecutive images of 10 cut images.

The preview content 310 may be configured to have a length corresponding to the cut images 311 to 313 included in the preview content 310. The control unit 130 may output a portion 311 of the preview content 310 having a preset length to a display area 300.

As illustrated in FIG. 3A, the display area 300 of the user terminal 200 may be divided into a plurality of areas depending on whether it is an area in which the preview content is provided. Specifically, the partial area 301 of the display area 300 of the user terminal 200 in which the preview content 310 is provided may be referred to as a “first area” or “preview area” and described with the same reference numeral “301.” In addition, the remaining area where the preview content 310 is not provided may be referred to and described as a “second area 302.”

The positions of the first area (or preview area 301) and the second area 302 within the display area 300 may exist to be preset by the system 100 for providing content.

As illustrated in FIG. 3A, the control unit 130 may control the display unit of the user terminal 200 to provide the preview content 310 in the first area 301 that is preset, and not provide the preview content 310 in the second area 302. In this case, the control unit 130 may display (output) various information related to the specific content (e.g., a title, author name, ratings, etc. of the specific content) in the second area 302.

As described above, the control unit 130 may perform first data processing to control the display unit of the user terminal 200 to provide the preview content 310 in the first area 301 of the display area 300 of the user terminal 200, and may perform second data processing to control the display unit of the user terminal 200 to provide information related to the specific content in the second area 302 excluding the first area 301.

In the present invention, based on receiving a scrolling request for the preview area, a process of changing an output range of the preview content output to the preview area may be performed (S220, see FIG. 2).

The output range of the preview content 310 output to the first area 301 may be configured to be changed based on a scroll request for the first area 301.

As described above, the preview content may be configured to have a preset length. Further, in the first area 301 of the display area 300, a partial range of the preview content having the preset length may be output.

Based on receiving a scroll request for the first area 301, the control unit 130 may change the output range of the preview content so that a different portion of the preview content is output in the first area 301, other than the portion of the preview content that is being output in the first area 301.

For example, as illustrated in FIG. 3A, the control unit 130 may receive a scrolling request for the first area 301 while the first cut image 311 corresponding to a first range is being provided in the first area 301. As illustrated in FIG. 3B, based on the scroll request, the control unit 130 may output the second cut image 312 corresponding to a second range different from the first range in the first area 301. In addition, as illustrated in FIG. 3C, based on continuously receiving scrolling requests for the first area 301, the control unit 130 may output a portion of the preview content corresponding to a third range that is different from the second range (e.g., a portion of the second cut image 312 and a portion of the third cut image 313) in the first area 301.

In the present invention, based on the output range of the preview content corresponding to a preset range, a process of providing a graphic object related to viewing the specific content in the preview area may be performed (S230, see FIG. 2).

As illustrated in FIG. 3D, the control unit 130 may control the display area 300 to output a graphic object 320 linked to a viewing request for a specific episode in the display area 300 in conjunction with the preview content 310 of the output range corresponding to a preset range in the first area 301 being output.

Here, the preset range may be understood as a specific range of the preview content 310 having a predetermined length that is preset to output the graphic object 320.

For example, the preset range may exist to be preset to a range corresponding to the very last cut image 313 of the plurality of cut images that make up the preview content 310. In another example, the preset range may be preset to a predetermined range that includes a lowermost side of the very last cut image 313 of the preview content 310 (e.g., a range corresponding to 150 pixels based on the lowermost side of the last cut). As another example, the preset range may be preset to a predetermined range that includes a central area (or portion) of the very last cut image 313 of the preview content 310 (e.g., a range corresponding to 150 pixels above with respect to the central area). However, the aforementioned range is merely an example, and the range set for providing a graphic object related to viewing the specific content is not limited thereto.

The control unit 130 may change the output range of the preview content 310 output in the first area 301 based on a scroll request for the first area 301. Further, the control unit 130 may monitor (or identify) whether the changed output range corresponds to the preset range. Depending on the monitoring result, the control unit 130 may determine whether to output the graphic object 320 in the display area 300.

For example, assume that a predetermined range that includes the lowermost side of the last cut image 313 of the plurality of cut images 311 to 313 that make up the preview content 310 is preset to be linked to the output of the graphic object 320. As illustrated in FIG. 3C, as a result of the monitoring, the control unit 130 may continuously output the preview content 310 only in the display area 300, and not output the graphic object 320, even if a portion of the very last cut image 313 of the preview content 310 is output in the first area 301, when a preset range (e.g., a predetermined range including the lowermost side of the last cut image 313) is not output in the first area 301.

In contrast, as illustrated in FIG. 3D, as a result of the monitoring, the control unit 130 may display the graphic object 320 related to viewing the specific content in the display area 300, when a preset range (e.g., a predetermined range including the lowermost side of the last cut image 313) of the preview content 310 is output in the first area 301.

In this case, the graphic object 320 may include a variety of information related to the specific content. For example, as illustrated in FIG. 3E, the graphic object 320 may include at least one of guidance information to guide viewing of specific content (e.g., “Don't miss this interesting story”), a thumbnail 321 of a specific episode, or descriptive information on the specific episode (e.g., “Sam's Life,” “Episode 1,” 322, 323).

As described above, the control unit 130 may perform different data processing related to the output of the graphic object 320 depending on the output range of the preview content 310 while the preview content 310 is provided in the preview area 301.

Specifically, the control unit 130 may perform first data processing to provide the graphic object 320 related to the viewing of the specific content in conjunction with the preview content 310 corresponding to the preset range being output in the first area 301.

In contrast, when the preview content 310 not corresponding to the preset range is output to the first area 301, the control unit 130 may perform a second data processing to continuously output the preview content 310 in the first area 301 without providing the graphic object 320 related to the viewing of the specific content.

Further, as illustrated in FIG. 3D and FIG. 3E, the preset range of the very last cut image 313 of the preview content 310 may be subjected to visual effects processing in a preset method.

Visual effects may refer to effects that are used to composite frames in a video (or image) or picture to visually process (or express) them. These visual effects are used in a variety of fields (e.g., visual media such as films, games, advertisements, and TV) to provide a spectacular visual experience or to enhance realism.

For example, the preset methods for processing visual effects may include at least one of gradation, color gradient, blending, morphing, alpha blending, or texture mapping. However, the methods described above are only examples, and the methods for processing visual effects are not limited thereto.

The control unit 130 may apply the visual effects processing of a preset method to the corresponding range, in conjunction with the preset range of the very last cut image 313 of the preview content 310 being output. For example, the control unit 130 may perform visual effects processing on the bottom portion (a range corresponding to 150 pixels with respect to the lowermost side) of the last cut image 313 of the preview content.

According to one aspect of the present invention, the graphic object 320 related to viewing the specific content may exist to be linked to a specific episode of the plurality of episodes that make up the specific content.

Here, a specific episode may refer to the very first episode of the plurality of episodes that make up the specific content.

As illustrated in FIG. 3E, when a selection is made of the graphic object 320 from the user terminal 200, the control unit 130 may process the selection of the graphic object 320 as a viewing request for the very first episode of the plurality of episodes that make up the specific content.

That is, based on the selection of the graphic object 320 from the user terminal 200, the control unit 130 may process the selection so that the viewing request for a specific episode (the very first episode) of the plurality of episodes that make up the specific content is received.

The control unit 130 may, based on the viewing request for the specific episode, provide the specific episode to the user terminal 200.

In this case, the control unit 130 may, using an episode viewer, provide a specific episode corresponding to the received viewing request.

Specifically, as illustrated in FIG. 3F, based on the viewing request for the specific episode, the control unit 130 may control the display unit of the user terminal 200 to switch the display area 300 of the user terminal 200, where the preview content 310 was output, to a viewer screen (or viewer page 350) corresponding to the episode viewer. The control unit 130 may control the user terminal 200 to execute an episode viewer for providing the specific episode based on the viewing request for the specific episode, and may provide the viewer screen of the episode viewer to the display area.

The control unit 130 may continue to provide at least a portion of the preview content that was being output in the preview area prior to the execution of the episode viewer on the viewer screen. In this case, the switched viewer screen may provide the specific episode in sequence, following the preview content 310.

As illustrated in FIG. 3F, the control unit 130 may provide, on the viewer screen 350, a specific cut image 361 that includes a lower portion of the preview content 310 from the specific episode, as well as another cut image 362 that is arranged sequentially after the specific cut image. The cut image 361 provided in a first area 360 of the viewer screen is a very last cut image of the plurality of cut images 311 to 313 that make up the preview content 310 (see reference numeral “313” in FIG. 3E). The cut image 362 provided in a second area 370 of the viewer screen 350 may be a cut image arranged after the very last cut image 361 among the plurality of cut images that make up the specific episode.

The control unit 130 may control an initial screen of the viewer screen to include the lower portion of the preview content when the episode viewer is executed. When the episode viewer is executed, the initial screen of the viewer screen may display at least a portion 361 of the preview content that was being output in the preview area prior to the execution of the episode viewer, along with the specific episode. In this case, the lower portion (end area) of the preview content may be included in an area corresponding to a preset proportion (e.g., 50%) of the initial screen.

The control unit 130, while displaying the lower portion of the preview content on the viewer screen, may provide the cut images included in the specific episode to the user terminal 200 sequentially following the lower portion of the preview content, when a scroll request for the user terminal 200 is input.

As described above, the preview content in the present invention may be understood as content included in the specific episode. The preview content 310 may be configured to include the plurality of cut images 311 to 313. The plurality of cut images 311 to 313 included in the preview content 310 may correspond to a portion of the plurality of cut images that make up the specific episode. For example, assuming that a specific episode is made up of 10 cut images, the preview content may be made up of the first to third cut images 311 to 313 among the 10 cut images. The control unit 130 may provide, on the viewer screen, an environment in which a user who was using the preview content may continuously use the specific content by displaying a fourth cut image in succession to the third cut image.

Based on the viewing request for the specific episode, the control unit 130 may provide both the cut images of the preview content and the cut images of the specific episode together on the viewer screen. The cut images provided together based on the viewing request may correspond to the very last cut image of the plurality of cut images in the preview content and the very first cut image of the plurality of cut images in the specific episode.

The preset range of the preview content may correspond to an end area of the very last cut image of the preview content. The control unit 130 may provide the viewer screen 350 with the plurality of cut images of the specific episode starting from an end area of a specific cut image that corresponds to the very last cut image of the preview content. The control unit 130 may control the specific episode to be scrolled to the end area of the specific cut image, in conjunction with a switch being made to the viewer screen 350 on the user terminal 200. The control unit 130, while the end area of the specific cut image is being output on the viewer screen, may change the output range of the specific episode output on the viewer screen 350 when a scroll request for the viewer screen is received. The user may directly view the specific episode (e.g., first episode) from a scene corresponding to the end area of the preview content simply by selecting the graphic object while viewing the preview content. The user may either scroll back to view again the beginning part (cut images corresponding to the preview content) or continue viewing the next part (subsequent cut images following the preview content) of the specific episode.

As described above, the control unit 130, based on the viewing request, may perform data processing to control the display unit of the user terminal 200 so that the very last cut image of the plurality of cut images in the preview content 310 and the cut image (or the very first cut image) that is arranged after the very last cut image among the plurality of cut images in the specific episode are provided together in an area of the switched viewer screen, thereby guiding the user who used the preview content to continue using the content.

In the present invention, different user environments related to content usage may be provided based on the content viewing history of a user account that is subscribed to the content providing service.

The control unit 130 may receive a selection signal for at least one specific content provided by the content providing service from the user terminal 200.

The control unit 130 may identify whether a viewing history exists for the specific content in the user account logged into the user terminal 200, based on the receipt of the selection signal for the specific content.

As illustrated in FIG. 4, in the storage unit 120, history information 400 that includes content viewing history may exist to be linked for each of a plurality of user accounts subscribed to the content providing service. For example, in the history information 400, at least two of work information (e.g., “title”), author information (e.g., “author name”), viewing history information (e.g., “viewing history”), or viewed episode information (e.g., “viewed episode”) for specific content may exist to be matched with each other.

Based on receiving a selection signal for the specific content from the user terminal 200, the control unit 130 may provide a content page 500 shown in FIG. 5A to provide information on the specific content to the user terminal 200.

In an area 520 of the content page 500, a plurality of tab icons 521 and 522 may be displayed for switching to different information display areas.

As illustrated in FIG. 5A, among the plurality of tab icons 521 and 522 included in the content page 500, a first tab icon 521 may be configured to be associated with a control command for providing a preview area in which the preview content 310 is output in at least one area 520 of the content page 500.

As illustrated in FIG. 5B, among the plurality of tab icons 521 and 522 included in the content page 500, a second tab icon 522 may be configured to be associated with a control command for providing a list of the plurality of episodes that make up the specific content in at least one area 520 of the content page 500.

The control unit 130 may activate one of the plurality of tab icons 521 and 522 included in the content page 500 depending on whether a viewing history for the specific content exists in the user account.

To this end, when the control unit 130 receives a selection signal for the specific content from the user terminal 200, the control unit 130 may refer to the history information 400 to identify the viewing history for the specific content in the user account logged into the user terminal 200.

Based on a result of the identification, the control unit 130 may activate one of the plurality of tab icons 521 and 522 included in the content page 500. Further, the control unit 130 may provide different information (preview content or a list) related to the specific content to the user terminal 200, depending on which tab icon 521 or 522 is activated.

For example, assuming that a selection signal for a first work (e.g., “Sam's Life”) is received from the user terminal 200 logged in with a first user account U1, as illustrated in FIG. 4, the control unit 130 may identify that there is no viewing history for the first work in the first user account U1.

As illustrated in FIG. 5A, based on the absence of a viewing history for the first work in the first user account U1, the control unit 130 may activate the first tab icon 521 of the plurality of tab icons 521 and 522 included in the content page 500. Further, in conjunction with the activation of the first tab icon 521, the control unit 130 may provide a preview area including the preview content 310 to the display area 300 of the user terminal 200. That is, the control unit 130 may perform first data processing to provide the preview content corresponding to a selection signal in the preview area.

In contrast, assuming that a selection signal for a first work (e.g., “Sam's Life”) is received from the user terminal 200 logged in with a second user account U2, as illustrated in FIG. 4, the control unit 130 may identify that there is a viewing history for the first work in the second user account U2.

As illustrated in FIG. 5B, based on the presence of a viewing history for the first work in the second user account U2, the control unit 130 may activate the second tab icon 522 of the plurality of tab icons 521 and 522 included in the content page 500. Further, in conjunction with the activation of the second tab icon 522, the control unit 130 may perform second data processing to output a list of the plurality of episodes that make up the first work in the display area 300 of the user terminal 200.

As described above, when the control unit 130 receives a selection signal for the specific content, the control unit 130 may perform different data processing to provide different information (preview content or a list) related to the specific content, depending on whether there is a viewing history for the specific content in the user account.

In response to receiving a selection signal from the user terminal 200 for one of the first tab icon 521 or the second tab icon 522, the control unit 130 may activate the selected tab icon.

Based on the selection of the second tab icon 522 while the first tab icon 521 of the plurality of tab icons 521 and 522 is activated, the control unit 130 may activate the second tab icon 522. Further, in conjunction with the activation of the second tab icon 522, the control unit 130 may output the preview content 310 disappears and the episode list for the specific content in the display area 300 of the user terminal 200. In this case, based on the absence of a viewing history for the specific content in the user account, the control unit 130 may provide a graphic object (see reference numeral “530” in FIG. 5B) linked to a viewing request for the very first episode among the plurality of episodes that make up the specific content.

Based on the selection of the graphic object 530 from the user terminal 200, the control unit 130 may receive a viewing request for a first episode linked to the graphic object 530. The control unit 130 may, in response to receiving the viewing request, use an episode viewer to provide the very first episode corresponding to the viewing request to the user terminal 200.

Further, based on the selection of the first tab icon 521 while the second tab icon 522 of the plurality of tab icons 521 and 522 is activated, the control unit 130 may output the preview content 310 in the display area 300.

As illustrated in FIG. 6, when the second tab icon 612 is activated, the control unit 130 may control the list movement (or scroll anchoring) such that, in the display area 600, an episode list 621 is output based on the most recent viewed episode information (e.g., 96th, “Episode 96”) in the user account and the next episode information following the most recent viewed episode (e.g., 97th, “Episode 97”), in a state where the episode list 621 is output based on the information on the latest episode (e.g., 100th, “Episode 100”). That is, the control unit 130 may sort the episode list 621 so that the information of episodes serialized after the specific episode viewed in the user account, among the plurality of episodes that make up the specific content, is included in the display area 600.

Specifically, when the second tab icon 612 is activated in a user account that has a viewing history for the specific content, the control unit 130 may refer to the history information on the user account and control the display unit of the user terminal 200, where the user account is logged in, such that the list 621 of the plurality of episodes output in one area 620 of a content page displayed in the display area 600 is moved (or scroll anchored) to the most recently viewed episode of the user account.

Here, the activation of the second tab icon 612 may be understood as occurring in at least one of when the control unit 130 controls the second tab icon 612 to be activated based on the viewing history of the specific content in the user account, or when the second tab icon 612 is activated by a user's activation request (or selection) for the second tab icon 612.

For example, as illustrated in FIG. 6, assuming that the most recently viewed episode of the user account is the 96th episode (“Episode 96”), based on the activation of the second tab icon 612 in the user account, the control unit 130 may control the list 621 of the plurality of episodes output in the second area 620 to move to the 96th episode (“Episode 96”), which is the most recently viewed episode of the user account.

Further, the control unit 130 may control the display unit of the user terminal 200, where the user account is logged in, such that the list 621 of the plurality of episodes is sorted sequentially (e.g., in ascending or descending order) and provided, starting from the episodes serialized after the most recently viewed episode of the user account.

In this case, the control unit 130 may control the display unit of the user terminal 200 so that, even if a scroll input is made on the second area 620 that includes the list 621 of the plurality of episodes, the plurality of tab icons 611 and 612 displayed in the first area 610 is provided in a fixed state.

That is, when the control unit 130 receives a selection signal from a user account with a viewing history for specific content, the control unit 130 may, based on the received selection signal, perform second data processing to control the display unit of the user terminal 200 such that a list of the plurality of episodes making up the specific content is provided in one area of the content page.

As described above, the control unit 130 may provide a user environment in which users may more easily access new content and continue using the content by performing different data processing according to the specific content viewing history that exists for each user account.

A method of providing preview content in the present invention may vary widely. The present invention may provide a user environment in which the user may explore preview content for a plurality of content provided by the content providing service.

For example, as illustrated in FIG. 7 and FIG. 8, the control unit 130 may provide content information (e.g., thumbnails, content title, author name, etc.) on at least one piece of content provided by the content providing service on the service pages 700 and 800. The control unit 130 may, based on the selection of the content information corresponding to the specific content, receive a selection signal for the specific content. In response to the selection signal for the specific content, the control unit 130 may output the preview content for the specific content in the display area 300 of the user terminal 200. In this case, the control unit 130 may identify whether there is a viewing history for the specific content in the user account logged into the user terminal 200 and provide either the preview content or an episode list for the specific content.

Further, as illustrated in FIG. 9A, the control unit 130 may provide a plurality of thumbnail objects 921, 931, 941, and 951 along with preview content 922 corresponding to a specific thumbnail object in the display area 300. The control unit 130 may control the display area of the user terminal 200 to be configured as a preview area (or first area, 910) where the preview content is provided, and a thumbnail area (or second area, 920) that includes thumbnails for specific content.

The thumbnail area 920 may include the plurality of thumbnail objects 921, 931, 941, and 951, each corresponding to different content.

The control unit 130, when a specific thumbnail object corresponding to specific content is selected among the plurality of thumbnail objects 921, 931, 941, and 951, may perform data processing to control the display unit of the user terminal 200 so that the preview content for the selected specific content is provided in the preview area 910 of the display area 900 of the user terminal 200.

For example, as illustrated in FIG. 9A, based on the selection of a first thumbnail object 921 corresponding to first content among the plurality of thumbnail objects 921, 931, 941, and 951 in the thumbnail area 920, the control unit 130 may control the display unit of the user terminal 200 so that the first preview content 922 for the first content is provided.

The preview area 910, in which the first preview content 922 is output within the display area 900 of the user terminal 200, may be scrolled on the display area 900 of the user terminal 200 based on a user input received from the user terminal 200, such that the output range of the previously output first preview content 922 is changed.

That is, based on a scroll input (or request) for the preview area 910 received from the user terminal 200, the control unit 130 may control the display unit of the user terminal 200 such that the first preview content 922 output in the preview area 910 scrolls (or moves) vertically (or horizontally).

As illustrated in FIG. 9A, based on a scroll input in a specific direction (vertical), the control unit 130 may control the display unit of the user terminal 200 so that a portion of a very last cut image 923 of the first preview content 922 is output in the preview area 910. When it is determined that the output range corresponds to a preset range, the control unit 130 may control the display unit of the user terminal 200 so that a graphic object 925 related to the viewing of the specific content is provided.

When a touch input request is received from the user terminal 200 in a preset direction for the preview area 910, the control unit 130 may control the display unit of the user terminal 200 to provide preview content for content different from the first preview content 922 that was output in the preview area 910.

For example, as illustrated in FIG. 9B, based on a touch input (or swipe) in a preset direction (horizontal) for the preview area 910 received from the user terminal 200, the control unit 130 may perform data processing to control the display unit of the user terminal 200 so that second preview content 932 is provided, for second content different from the first preview content 922 that was output in the preview area 910.

In this case, it is obvious that changing to different preview content may also be achieved through a touch input in a preset direction (horizontal) for the thumbnail area 920 or through selecting a thumbnail object in the thumbnail area 920.

Further, in the thumbnail area 920, a thumbnail object of the preview content currently being provided in the preview area 910 may be highlighted and displayed.

For example, as illustrated in FIG. 9A, assuming that the first preview content 922 for the first content is being provided in the preview area 910, the control unit 130 may control the display unit of the user terminal 200 so that the thumbnail object 921 for the first preview content 922 currently being provided in the preview area 910 is highlighted and displayed.

In this case, when the preview content of another content is provided in the preview area 910, the thumbnail object that is being highlighted in the thumbnail area 920 may be changed to a thumbnail object corresponding to the other content.

For example, as illustrated in FIG. 9A and FIG. 9B, while the first preview content 922 for the first content is currently being provided in the preview area 910, the control unit 130, based on the change to the second preview content 932 for second content that is different from the first preview content 922 by a user input, may control the display unit of the user terminal 200 to change the first thumbnail object 921, which was highlighted in the thumbnail area 920, to the second thumbnail object 931 of the changed second preview content 932.

As described above, the method and the system for providing content according to the present invention may provide preview content for specific content in a preset preview area corresponding to at least a portion of the display area. The user may identify specific content in advance through the preview content and may easily determine which content the user wishes to use through the content preview identified in advance. Therefore, the user may more easily access new content.

Further, the method and the system for providing content according to the present invention may change the output range of the preview content output in the preview area, based on receiving a scroll request for the preview area. The user may conveniently use the preview content with simple operations.

Further, the method and the system for providing content according to the present invention may provide a graphic object related to viewing specific content in the preview area, based on the output range of the preview content corresponding to a preset range. Therefore, the user may conveniently obtain information on new content and easily access interesting content without needing to perform separate actions, such as searching. Further, the user may continuously use the content in succession to the preview content. Further, the content provider may effectively guide the consumption of content by the consumer and ensure continuous consumption of content by the consumer, thereby preventing consumer churn.

The present invention described above may be executed by one or more processes on a computer and implemented as a program that can be stored on a non-transitory computer-readable medium (or recording medium).

Further, the present invention described above may be implemented as computer-readable code or instructions on a medium in which a program is recorded. That is, the present invention may be provided in the form of a program.

The computer-readable medium includes all types of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

It should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of providing content to a user terminal that includes a display area, the method comprising:
providing preview content for specific content in a preset preview area corresponding to at least a portion of the display area;
changing, based on receiving a scroll request for the preview area, an output range of the preview content output in the preview area; and
providing, based on the output range of the preview content corresponding to a preset range, a graphic object related to viewing the specific content in the preview area.

2. The method of claim 1, wherein the specific content is made up of a plurality of episodes, and the graphic object is linked to a specific episode among the plurality of episodes.

3. The method of claim 2, wherein, when a selection of the graphic object is made from the user terminal, the selection is processed as a viewing request for the specific episode.

4. The method of claim 3, further comprising:
providing, based on the viewing request, the specific episode to the user terminal,
wherein in the providing of the specific episode, the user terminal is controlled to execute an episode viewer for providing the specific episode, based on the viewing request, and a viewer screen of the episode viewer is provided in the display area.

5. The method of claim 4, wherein the viewer screen continues to provide at least a portion of the preview content that was being output in the preview area prior to the execution of the episode viewer.

6. The method of claim 5, wherein, responsive to the episode viewer being executed, an initial screen of the viewer screen includes a lower portion of the preview content, and while the lower portion of the preview content is displayed on the viewer screen, responsive to a scroll request for the user terminal being input, the specific episode is provided to the user terminal sequentially following the lower portion of the preview content.

7. The method of claim 6, wherein the preview content is content included in the specific episode, and the viewer screen provides a specific cut image that includes the lower portion of the preview content from the specific episode, as well as another cut image arranged sequentially after the specific cut image.

8. The method of claim 7, wherein, responsive to the episode viewer being executed, an initial screen of the viewer screen displays at least a portion of the preview content that was being output in the preview area prior to the execution of the episode viewer, along with the specific episode, and, in response to a scroll input for the user terminal, the at least a portion of the preview content disappears from the viewer screen.

9. The method of claim 5, wherein the specific episode is made up of a plurality of cut images, and the preview content is made up of cut images of a portion of the plurality of cut images, and
wherein the viewer screen provides a specific cut image included in the specific episode, sequentially following a last cut image of the cut images of the portion in the preview content.

10. The method of claim 4, wherein, in the providing of the specific episode, at least a portion of cut images that make up the preview content is provided along with at least a portion of cut images that make up the specific episode.

11. The method of claim 10, wherein the preview content and the specific episode are each made up of a plurality of cut images, and cut images provided together based on the viewing request include a last cut image of the plurality of cut images in the preview content and a first cut image of the plurality of cut images in the specific episode.

12. The method of claim 2, wherein the specific episode is a first episode among the plurality of episodes that make up the specific content.

13. The method of claim 1, further comprising:
receiving a selection signal for the specific content from the user terminal;
identifying, based on the selection signal, whether there is a viewing history for the specific content in a user account logged into the user terminal; and
providing, based on a result of the identification, information related to the specific content to the user terminal,
wherein the preview content is provided to the user terminal, based on the selection signal, in the absence of viewing history for the specific content in the user account. absence

14. The method of claim 13, wherein, based on the result of the identification, in the existence of a viewing history for the specific content in the user account, a list of a plurality of episodes that make up the specific content is provided to the user terminal, and
wherein the list is sorted to include information on episodes serialized after an episode viewed by the user account among the plurality of episodes.

15. The method of claim 14, wherein, when the selection signal for the specific content is received, a content page for providing information on the specific content is provided to the user terminal,
wherein the content page displays a plurality of tab icons for switching to different information display areas, and
wherein a first tab icon of the plurality of tab icons is associated with a control command for providing the preview area in at least a portion of the content page, and a second tab icon of the plurality of tab icons is associated with a control command for providing the list in at least a portion of the content page.

16. The method of claim 15, wherein, in the providing of information on the specific content, based on the result of the identification, in the absence of viewing history for the specific content in the user account, the first tab icon is activated, and the preview area is provided in at least a portion of the content page, and based on the result of the identification, in the existence of a viewing history for the specific content in the user account, the second tab icon is activated, and the list is provided in at least a portion of the content page.

17. The method of claim 1, wherein the display area further includes a thumbnail area, the thumbnail area includes thumbnail objects, each corresponding to different content, and
wherein, when a specific thumbnail object corresponding to the specific content is selected among the thumbnail objects, preview content for the specific content is provided in the preview area.

18. The method of claim 17, wherein, based on receiving a touch input request in a preset direction for the preview area from the user terminal, preview content for content different from the specific content is provided in the preview area.

19. A system for providing content to a user terminal that includes a display area, the system comprising:
a control unit configured to provide preview content for specific content in a preset preview area corresponding to at least a portion of the display area,
wherein the control unit is configured to:
change, based on receiving a scroll request for the preview area, an output range of the preview content output in the preview area; and
provide, based on the output range of the preview content corresponding to a preset range, a graphic object related to viewing the specific content in the preview area.

20. A non-transitory computer-readable recording medium storing a program for enabling an electronic device to execute the steps comprising:
providing preview content for specific content in a preset preview area corresponding to at least a portion of the display area;
changing, based on receiving a scroll request for the preview area, an output range of the preview content output in the preview area; and
providing, based on the output range of the preview content corresponding to a preset range, a graphic object related to viewing the specific content in the preview area.
